(19) United States
(12) Patent Application Publication
(10) Pub. No.: US 2008/0071654 A1
(43) Pub. Date: Mar. 20, 2008

(54) Method, system, and apparatus for remittance processing over a network

(76) Inventor: Jay Cohen, Lawrence, NY (US)

Correspondence Address: DARBY & DARBY P.C., P.O. BOX 770, Church Street Station, New York, NY, 10008-0770, US

(21) Appl. No.: 11/512,047

(22) Filed: Aug. 28, 2006

(51) Int. Cl. G06Q 40/00; H04L 9/00

(52) U.S. Cl. 705/35; 705/61

(57) ABSTRACT

A method, system, and apparatus directed to remittance processing over a network. Information associated with a payment made to a merchant is received at a transaction verification intermediary (TVI). In response to the received information, a payment is made by the TVI to a merchant account at a financial repository of the merchant (FRM). Information about transactions made by the merchant is sent from the TVI to a third party. In response, the third party sends a request to the FRM for remittance of a portion of the merchant's funds managed by the FRM. The portion may be determined by a right to a future percentage of payments made to the merchant. The requested portion of the merchant's fund is debited and sent by the FRM to the third party. Once the total amount of the third party's payments is received, the remittance processing is finalized.

### FIELD OF THE INVENTION

The present invention relates generally to electronic financial transactions, and more particularly, but not exclusively, to remittance processing over a network.

### BACKGROUND OF THE INVENTION

Electronic financial transactions generally involve fund transfers, through, for example, card transactions (e.g., credit, debit, charge, smart, etc.), online e-commerce transactions, or the like.

Cards may be used by being presented at a physical merchant, as part of a telephone transaction, or over the Internet. Card transactions generally involve at least merchants, merchant processors, issuers, and cardholders. Such transactions include authorization, clearing, and settlement processes, and may include the use of a system such as the VisaNet or Cirrus system to authorize, clear, and settle the card payment. Cards have also become one of the most common forms of payment for e-commerce transactions.

U.S. Pat. No. 6,826,544 to Johnson, and U.S. Pat. No. 6,941,281 to Johnson (“the Johnson patents”), which are incorporated herein by reference, describe systems and methods for loan repayment utilizing consumer payment authorization, clearing, and settlement systems to allow a merchant to reduce an outstanding loan amount. The Johnson patents are directed to modifying a conventional merchant processing system. In the conventional system, a merchant accepts credit card payments from a cardholder. The merchant then communicates the credit card transaction information to a merchant processor. In turn, the merchant processor communicates through a network to the credit card issuer in order to verify the credit card transaction and to then credit to the merchant the full amount of the credit card transaction, less processing fees.

According to the Johnson patents, the conventional merchant processor is modified in order to allow for automated repayment of loans. When the merchant processor receives confirmation to credit the merchant's account with the amount of the credit card transaction, the merchant processor pays a portion of the credit card transaction amount directly to a lender from whom the merchant has previously taken out a loan. The remaining amount of the credit card transaction is then credited by the merchant processor to the merchant. In this way a merchant can automatically repay a loan by having a portion of future credits, which are to be credited to the merchant, go directly to the lender before they ever reach the merchant's bank account.

Generally, transactions made by a merchant are reflected in account receivables. In some cases, the merchant may securitize or sell the account receivables (e.g. debts), including exchanging a right for the account receivables in exchange for some amount of money.

### SUMMARY OF THE INVENTION

One embodiment of the invention is directed to a method for remittance processing over a network. This method includes the step of receiving at a transaction verification intermediary (TVI) from a merchant, information associated with a payment to be made to the merchant. The method also includes the TVI crediting the merchant with the payment amount, less processing fees. The method includes receiving at a third party from the TVI, information about a plurality of payments made to the merchant, for example, to a financial repository of a merchant (FRM). In one embodiment, the information about the payments includes information about payments made to the merchant during a period of time, such as during a day, a week, a month, a year, or the like. The method also includes sending from the third party to the FRM, a request for remittance of at least a portion of the payments made to the merchant. The request for the remittance includes an automated clearing house request or a funds transfer request. The method also includes receiving at the third party from the FRM, the portion of the merchant's payments from the FRM, in response to the request.

The step of determining a portion of a fund of a merchant to be remitted to the third party may be based on a percentage of the payments made by a customer to the merchant. This determination may occur at a third party, or the like. The step of determining may include the step of receiving financial electronic data interchange (FEDI) data about the payments made during a period of time or made in real-time. The determined portion may be determined based on the received FEDI data. The method also includes sending a request to an FRM, for remittance of the determined portion of the merchant's funds.

Another embodiment of the invention is directed to a system for remittance processing over a network involving a TVI, a third-party, a FRM, and a merchant. The third-party may be in communication with the TVI and FRM. The merchant may be in communication with the TVI. In one embodiment, the FRM comprises at least one of an electronic bank account, an online fund, or an online financial intermediary.

The TVI may be operable to perform actions, which include receiving information associated with a payment made to the merchant. The merchant may receive the information associated with the payment from a customer via a credit card transaction. The information associated with the payment made to the merchant may include FEDI data, a customer identifier, a card identifier, or an e-commerce identifier. The TVI operates to send to the third party, information about transactions made by the merchant. The TVI may send this information periodically (e.g. daily), for the transactions occurring within such periods.

Another embodiment of the invention is directed to a processor readable medium for remittance processing over a network. The processing of the data by the processor includes determining a portion of a merchant's funds to be remitted to a third party based on a percentage of payments made by customers; sending a request for remittance of a portion of the funds; and receiving the portion of the funds.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 is a functional block diagram illustrating an environment for practicing the invention;

FIG. 2 is a block diagram of one embodiment of a network device that may be included in a system implementing the invention;

FIG. 3 is a logical flow diagram generally showing one embodiment of a process for remittance processing over a network, in accordance with the present invention; and

FIG. 4 is a logical flow diagram generally showing another embodiment of a process for remittance processing over a network, in accordance with the present invention.

### DETAILED DESCRIPTION OF THE INVENTION

The present invention will now be described more fully with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods or devices. Accordingly, the invention may take the form of an entirely hardware embodiment, an entirely software embodiment or an embodiment combining software and hardware aspects. The following detailed description is, therefore, not to be taken in a limiting sense.

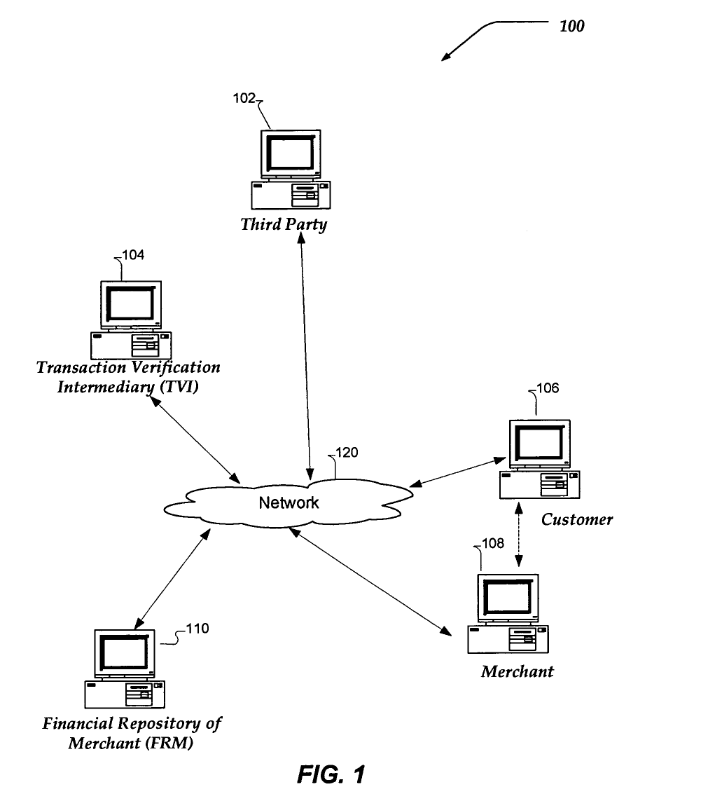

FIG. 1 illustrates one embodiment of an environment in which the invention may operate. However, not all of the illustrated components may be required to practice the invention, and variations in the arrangement and type of the components may be made without departing from the spirit or scope of the invention.

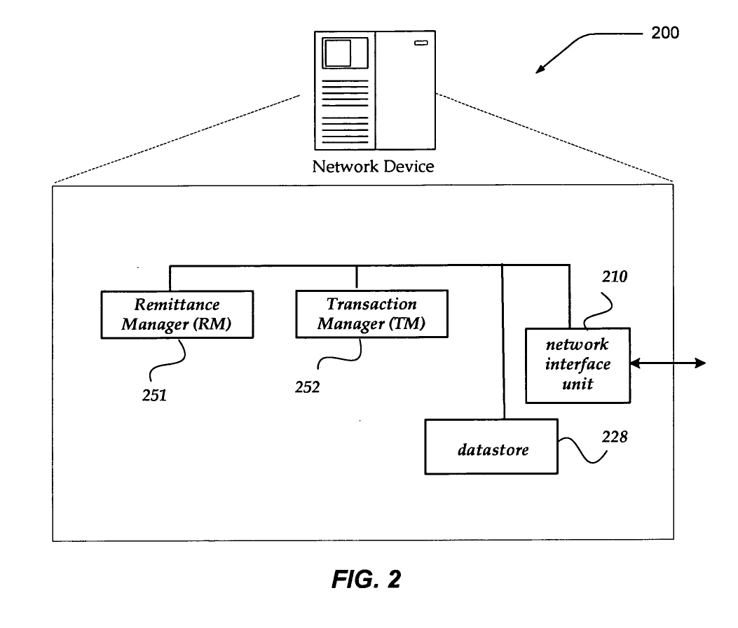

As shown in FIG. 1, system 100 includes Financial Repository of a Merchant (FRM) 110, Transaction Verification Intermediary (TVI) 104, merchant 108, network 120, customer 106, and third party 102. An embodiment of a network device that could be used as TVI 105 and/or third party 102 is network device 200 of FIG. 2, configured with appropriate software. Network 120 may be in communication with FRM 110, merchant 108, TVI 104, customer 106, and third party 102. Customer 106 may also be in direct communication with merchant 108, via a physical presence at a merchant or through a telecommunication line.

TVI 104 includes appropriate mechanisms for enabling verification of a transaction, and settling funds for the transaction. TVI 104 may include a merchant processor and/or an online financial intermediary, or the like. Online financial intermediaries may permit a consumer to establish an online account, and to transfer funds into the online account from a traditional bank account, and vice versa, and to make FEDI payments with the online account. TVI 104 may be the same as FRM 110, a card issuer (not shown) of the card that is being used for a transaction, or the like. TVI 104 may be in communication with the card issuer and/or FRM 110 to enable TVI 104 to verify that a transaction is legitimate and should be settled. TVI 104 may use the VisaNet or Cirrus system to authorize, clear, and/or settle the transaction.

FRM 110 includes appropriate mechanisms for managing funds associated with a merchant, such as merchant 108, and for sending and receiving information about the funds. FRM 110 may include the merchant's bank, an electronic mechanism for managing the merchant's bank account, an online financial intermediary for managing the merchant's online financial accounts, or the like.

Merchant 108 includes appropriate mechanisms for processing a transaction with a customer and communicating transaction information over a network.

Customer 106 includes appropriate mechanisms for initiating a transaction, such as an online purchase, a card purchase for a product and/or service, or the like. As shown, customer 106 may initiate a transaction with merchant 108 over network 120 via an e-commerce mechanism, or the like. In another embodiment, customer 106 may initiate a transaction with merchant 108 at a brick-and-mortar store, over the phone, or the like.

Third party 102 includes appropriate mechanisms for managing remittances over a network, including transferring money electronically from various accounts. Third party 102 may acquire a right to receive a portion of future credit card transactions transacted by merchant 108. In return, third party 102 provides an amount to merchant 108 for this right. Subsequently, financial transactions are processed by FRM 110 on behalf of the merchant 108 and the full amount of the transaction is credited to the merchant's bank account, in a fairly conventional manner, as described below. As an example, the third party may provide an amount of $20,000 in return for the right to receive 5% of merchant 108's credit card receipts until $25,000 has been collected by the third party. In this way, merchant 108 receives a present amount of money and the third party profits by providing $20,000, which is collected as $25,000 over time.

Merchant 108, FRM 110, TVI 104, network 120, and customer 106 operate in a fairly conventional manner to complete a transaction. In one embodiment, customer 106 provides merchant 108 with credit card information for a transaction. Then, the credit card information is sent via network 120 to TVI 104. Transactions are processed by TVI 104 acting as an online financial intermediary, or the like, on behalf of merchant 108 and the full amount of the transaction (or the full amount less fees) is credited to the merchant's bank account through FRM 110. In another embodiment, transactions are processed by TVI 104 acting as a merchant processor, or the like, on behalf of merchant 108. For example, in this embodiment, TVI 104 may verify the transaction with a card issuer (not shown) and/or an online financial intermediary (not shown) over network 120, or the like. TVI 104 may act as the card issuer and/or the online financial intermediary. In this case, TVI 104 verifies the transaction by confirming the identity of merchant 108 and/or customer 106, available funds of customer 106, whether the transaction is authorized or the like. After verification of the transaction, TVI 104 may remit money associated with the transaction to FRM 110 over network 120, or the like. FRM 110 may then credit the money to the merchant's account.

Subsequently, a remittance process may be invoked to remit a portion of the merchant's funds managed by FRM 110 to third party 102. For example, on a periodic basis, TVI 104 may send over network 120, to third party 102, information about credit cared transactions for merchant 110. In response, third party 102 may send, over network 120, a funds transfer request, or the like, to FRM 110, to pay an amount of the merchant's credit card transactions to third party 102. This amount may be determined as a percentage of the merchant's credit card receipts. The appropriate portion of the merchant's funds in FRM 110 is then remitted to third party 102, over network 120.

Generally, TVI 104, third party 102, customer 106, merchant 108, and FRM 110 (collectively “the network devices”) may include virtually any computing device capable of performing the operations described above and capable of connecting to another computing device to send and receive information, including web requests for information from a server, and the like. The set of such devices may include devices that typically communicate using a wired and/or wireless communications medium such as personal computers, multiprocessor systems, microprocessor-based or programmable consumer electronics, network PCs, or the like.

Network 120 is configured to couple the network devices together and/or with other network devices, or the like, employing, for example, a variety of network interfaces and associated communication protocols. Network 120 may employ wireless and/or wireless access technologies. Network 120 is enabled to employ any form of computer readable media for communicating information from one electronic device to another. The computer-readable instructions may include data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal.

Moreover, network 120 may provide specific functionality for financial transactions, such as securing card transactions, money transfers, or the like. Network 120 may include interbank networks, including VisaNet, Cirrus, or the like. Network 120 may be an aggregate of networks including interbank networks, the Internet, or the like.

It is further noted that terms such as client and server device may refer to functions within a device. As such, virtually any device may be configured to operate as a client device, a server device, or even include both client and server functions. Furthermore, where two or more peers are employed, any one of them may be designated as a client or as a server, and be configured to operate in accordance with the teachings of the present invention.

### Illustrative Network Device

FIG. 2 shows one embodiment of a network device, according to one embodiment of the invention. Network device 200 may represent at least some components of, for example, third party 102 and/or TVI 104 of FIG. 1 configured as appropriate to the particular application, i.e., third party, TVI, etc. As shown, network device 200 includes Remittance Manager (RM) 251, Transaction Manager (TM) 252, network interface unit 210, datastore 228. Network interface unit 210 may include any mechanism for enabling communication between devices over a network, such as network 120 of FIG. 1. Datastore 228 may include any structured data storage mechanism, including a database, spreadsheet, text file, or the like. Each component of network device 200 may be in communication with each other and/or other components (not shown).

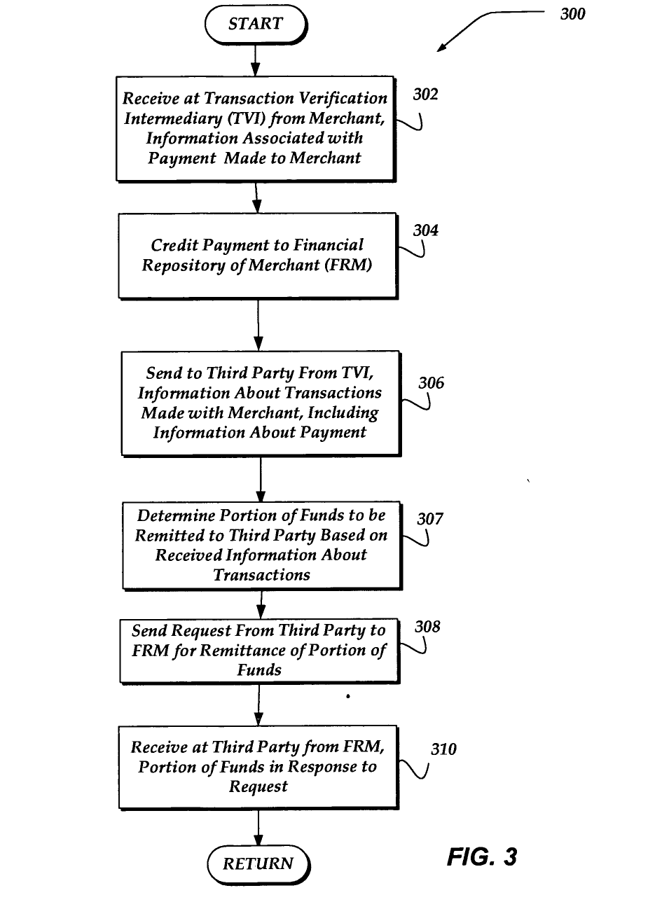

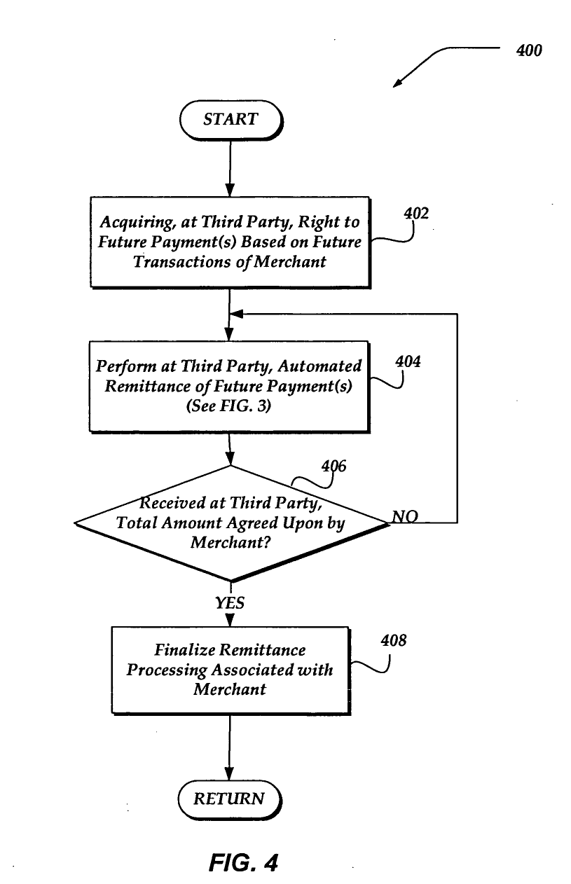

RM 251 may include any software and/or hardware component enabled to manage network traffic. RM 251 is enabled to perform the operations described in process 300 of FIG. 3 and/or in process 400 of FIG. 4. RM 251 may manage acquiring a right to future payments of a portion of transactions made by a merchant, over network interface unit 210, or the like. RM 251 may store in datastore 228, information about future payments to be made.

RM 251 may be enabled to send a request for remittance of at least a portion of a merchant's funds managed by the financial repository of the merchant (FRM) based on received information about payments made to the merchant. The information about the plurality of payments may be received over network interface unit 210, and the request may be sent over network interface unit 210. RM 251 may manage receiving the portion of the funds from the FRM, in response to the request over network interface unit 210, or the like. RM 251 may store information about the received funds in datastore 228, or the like.

TM 252 may include any software and/or hardware component enabled to manage network traffic. TM 252 is enabled to perform the operations described in process 300 of FIG. 3 and/or in process 400 of FIG. 4. TM 252 may manage receiving from a merchant, information associated with a merchant transaction and a payment to be made to the merchant, over network interface unit 210. TM 252 may store such information in datastore 228, or the like, for further processing. TM 252 may credit at least a portion of the payment to a merchant account, over network interface unit 210, or the like. TM 252 may also send to a third party, information about transactions from datastore 228.

### Generalized Operation

The operation of certain aspects of the invention will now be described with respect to FIGS. 3-4. FIG. 3 is a logical flow diagram generally illustrating one embodiment of a process for remittance processing. Process 300 of FIG. 3 may be implemented, for example, with the network devices of FIG. 1.

Process 300 begins, after a start block, at block 302, where information associated with a payment made to a merchant, such as merchant 108 of FIG. 1, is received at a transaction verification intermediary (TVI) from the merchant. The information associated with the payment made to the merchant is at least one of financial electronic data interchange (FEDI) data, a customer identifier, a card identifier, an e-commerce identifier, or the like. The information is sent over a network, or the like.

Next, processing proceeds to block 304 where the payment is credited by the TVI to the merchant, to a financial repository of the merchant (FRM) such as FRM 110 of FIG. 1, or the like. The FRM may include an electronic bank account, an online fund, an online financial intermediary, or the like. The FRM may perform database operations, or the like, to credit an amount in an electronic fund of the merchant, or the like.

Processing then continues to block 306, where information about transactions made by the merchant is sent to a third party from the TVI, over a network, or the like. The information about transactions may include information about payments made to the merchant during a period of time. The information about the merchant payments may be received by the third party in real-time, substantially in real-time, or periodically.

Processing then continues to block 307, where a portion of the funds paid to the merchant is determined by the third party, based on the received information about the transactions. This determination may be based on payments made to a merchant during a period of time, made in real-time, or the like.

Processing then continues to block 308, where a request for a remittance of the determined portion of funds is sent from the third party to the FRM, over a network, or the like. The request for remittance may include an automated clearing house request, a funds transfer request, or the like. The request may be automatic, performed periodically, or the like. The period for sending the request may be hourly, daily, monthly, yearly, or virtually any time period. In one embodiment, the period may encompass the period of time during which the merchant has received a plurality of payments, as described above with respect to block 304. In one embodiment, the request may be sent in response to receiving the information about the transactions. The FRM responds to the request by debiting the funds, or the like, and by making payment to the third party.

Next, processing continues to block 310, where the portion of the funds is received at the third party, in response to the request. Processing then returns to a calling process for further processing.

FIG. 4 illustrates a logical flow diagram generally showing the overall process for remittance processing. Process 400 of FIG. 4 may be implemented, for example, with the network devices of FIG. 1.

Process 400 begins, after a start block, at block 402 where, a third party acquires a right to receive future payments based on future transactions transacted by a merchant. In one embodiment, in return for the right, the third party provides a present amount to the merchant.

Next, processing continues to decision block 404, where remittance processing is invoked to remit a portion of the funds to be received by the merchant, as described in blocks 302-310 of FIG. 3.

Next, processing continues to decision block 406, where it is determined if a total amount associated with the acquired right to the future payments has been remitted to the third party from the FRM. If the total amount has been remitted, then processing continues to block 408. Otherwise, processing loops back to block 404.

At block 408, once the agreed upon amount of funds has been received by the third party, remittance processing is finalized. Processing then returns to a calling process for further execution, e.g., processing associated with a new remittance agreement.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

Since many embodiments of the invention can be made without departing from the spirit and scope of the invention, the invention resides in the claims hereinafter appended.

What is claimed is:

1. A method for remittance processing over a network, comprising the following steps:
receiving at a transaction verification intermediary (TVI) from a merchant, information associated with a merchant transaction and a payment to be made to the merchant;
crediting by the TVI, at least a portion of the payment to a merchant account at a financial repository of the merchant (FRM);
receiving at a third party from the TVI, information about the transaction made by the merchant including the payment made to the merchant;
sending from the third party to the FRM, a request for remittance of a portion of the payment made to the merchant based on the information about the merchant transaction; and
receiving at the third party from the merchant account at the FRM, the portion of the payment made to the merchant, in response to the request.

2. The method of claim 1, wherein the request for remittance is an automated clearing house request or a funds transfer request.

3. The method of claim 1, further comprising the step of receiving at the third party the information about a plurality of transactions made by the merchant during a period of time.

4. The method of claim 1, further comprising the step of receiving financial electronic data interchange (FEDI) data about payments made to the merchant during a predetermined period of time.

5. A method for remittance processing over a network, comprising the following steps:
(a) receiving at a third party, information about an amount of payment credited into a merchant's account;
(b) determining, at the third party, a portion of the payment made to the merchant which is to be remitted to the third party;
(c) sending a request for remittance of the portion of the merchant's payment;
(d) receiving the portion of the merchant's payment; and
(e) repeating steps (a)-(d) until a total amount agreed upon by at least the merchant is received by the third party.

6. A system for remittance processing over a network, comprising
a transaction verification intermediary (TVI) operable to perform actions comprising the following steps:
receiving from a merchant, information associated with a merchant transaction and a payment to be made to the merchant;
crediting at least a portion of the payment to a merchant account at a financial repository of the merchant (FRM);
sending to a third party, information about the transaction made by the merchant including the payment made to the merchant;
the third party in communication with the TVI over the network, and operable to perform actions comprising the following steps:
sending to the FRM, a request for remittance of a portion of the payment made to the merchant based on the information about the merchant transaction; and
receiving from the merchant account at the FRM, the portion of the payment made to the merchant, in response to the request.

7. The system of claim 6, wherein the information associated with the payment made to the merchant is at least one of financial electronic data interchange (FEDI) data, a customer identifier, a card identifier, or an e-commerce identifier.

8. The system of claim 6, wherein the FRM comprises at least one of an electronic bank account, an online fund, or an online financial intermediary.

9. The system of claim 6, wherein the requested portion of the fund is based on a percentage of payment made to the merchant.

10. The system of claim 6, wherein the step of sending to the third party the information about the transactions occurs periodically.

11. A programmed processor for remittance processing over a network, configured to perform the following steps:
(a) receiving at a third party, information about an amount of payment credited into a merchant's account;
(b) determining, at the third party, a portion of the payment made to the merchant which is to be remitted to the third party;
(c) sending a request for remittance of the portion of the merchant's payment;
(d) receiving the portion of the merchant's payment; and
(e) repeating steps (a)-(d) until a total amount agreed upon by at least the merchant is received by the third party.

12. The programmed processor of claim 11, wherein the determining step further comprises receiving information about the payment made to the merchant during a period of time.

13. A method for remittance processing over a network, comprising the following steps:
(a) providing, by a third party, a present amount for a right to receive future payments from a merchant;
(b) receiving at the third party, information about an amount of payment credited into a merchant's account;
(c) determining, at the third party, a portion of the payment made to the merchant which is to be remitted to the third party;
(d) sending a request for remittance of the portion of the merchant's payment;
(e) receiving the portion of the merchant's payment; and
(f) repeating steps (b)-(e) until the future payments agreed upon by at least the merchant are received by the third party.

14. A programmed processor for remittance processing over a network configured to perform the following steps:
(a) providing, by a third party, a present amount for a right to receive future payments from a merchant;
(b) receiving at the third party, information about an amount of payment credited into a merchant's account;
(c) determining, at the third party, a portion of the payment made to the merchant which is to be remitted to the third party;
(d) sending a request for remittance of the portion of the merchant's payment;
(e) receiving the portion of the merchant's payment; and
(f) repeating steps (b)-(e) until the future payments agreed upon by at least the merchant are received by the third party.
